(19) United States
(12) Patent Application Publication
(10) Pub. No.: US 2024/0369750 A1
(43) Pub. Date: Nov. 7, 2024

(54) LIDAR / INFRARED TRANSPARENT FINISH WITH METALLIC APPEARANCE

(71) Applicant: SRG GLOBAL, LLC, Troy, MI (US)

(72) Inventors: Robert Frayer, Huntington Woods, MI (US); Xuequn Hu, Northville, MI (US); Philip J. Lingle, Temperance, MI (US); James M. Shurish, Troy, MI (US)

(21) Appl. No.: 18/290,823

(22) PCT Filed: Aug. 19, 2022
(86) PCT No.: PCT/IB2022/057783

§ 371 Date: Jan. 22, 2024

Related U.S. Application Data
(60) Provisional application No. 63/236,715, filed on Aug. 25, 2021.

(51) Int. Cl. G02B 5/28; C03C 17/34; G02B 5/20

(52) U.S. Cl. CPC G02B 5/286; C03C 17/3482; G02B 5/207; G02B 5/282; C03C 2217/212; C03C 2217/213; C03C 2217/72

(57) ABSTRACT

An improved decorative finish with metallic appearance in the visible wavelength range with high transmission in the infrared (IR) wavelength range. A first surface physical vapor deposition (PVD) coating stack includes silicon as a color layer and a quarter wave stack for improved IR transmission. Base coat and top coat paints included can be included to provide exterior automotive performance. For example, standard paints for today's PVD solutions could be used. A quarter wave stack could optionally be used as it is a standard optical approach. The components/stacks have more flexibility with the target wavelength range. Silicon dioxide (SiO2) could be used as a representative “low index” material, and titanium dioxide (TiO2) could be used as a representative “high index” material. Plastic substrates with IR transmission should be required.

### CROSS-REFERENCE TO RELATED APPLICATION(S)

The present application claims the benefit of U.S. Provisional Application No. 63/236,715, filed on Aug. 25, 2021. The disclosure of the above-identified application is herein incorporated by reference in its entirety.

### FIELD

The present application relates to a decorative finish with metallic appearance in the visible wavelength range with high transmission in the infrared (IR) wavelength range.

### BACKGROUND

Metallic finish is defined as chrome appearance with a typical chrome plated finish. The focus for infrared (IR) wavelength range is 900 nanometers (nm) to 1550 nm, based on existing light detection and ranging (LIDAR) solutions. The functional wavelength, however, may be different depending on the LIDAR design/technology (905 nm, 940 nm, 1550 nm, etc.). For LIDAR applications, IR transmission greater than 85% is required, greater than 90% is preferred, and greater than 95% most preferred. Challenges for exterior automotive applications with high performance requirements include performance not known for concepts, appearance matching with chrome plating, transmission at IR wavelengths, whether to target specific wavelengths or the entire range, metal films typically not having the required IR transmission, and the like. Thus, while conventional metallic finish LIDAR devices do work for their intended purpose, there exists an opportunity for improvement in the relevant art.

The background description provided herein is for the purpose of generally presenting the context of the application. Work of the presently named inventors, to the extent it is described in this background section, as well as aspects of the description that may not otherwise qualify as prior art at the time of filing, are neither expressly nor impliedly admitted as prior art against the present application.

### SUMMARY

According to one aspect of the present application, a component having a decorative metallic finish in the visible wavelength range with high transmission in the infrared (IR) wavelength range is presented. In one exemplary implementation, the component comprises a substrate defining a front side and a back side, and a layer stack atop the front side of the substrate, the layer stack comprising a bottom coat layer atop the substrate, a silicon (Si) layer atop the bottom coat layer; one or more silicon dioxide (SiO2) layers atop the Si layer, one or more titanium dioxide (TiO2) layers atop and/or between the one or more SiO2 layers, and a top coat layer atop a top one of the one or more TiO2 layers.

In some implementations, the layer stack comprises only one SiO2 layer atop the Si layer and only one TiO2 layer atop the SiO2 layer. In some implementations, the one or more SiO2 layers comprise first and second SiO2 layers and the one or more TiO2 layers comprise first and second TiO2 layers. In some implementations, the first SiO2 layer is atop the Si layer, the first TiO2 layer is atop the first SiO2 layer, the second SiO2 layer is atop the first TiO2 layer, and a second TiO2 layer atop the second SiO2 layer. In some implementations, the component defines transmission greater than 87% at a 940 nanometer wavelength

According to another aspect of the present application, a component having a decorative metallic finish in the visible wavelength range with high transmission in the IR wavelength range is presented. In one exemplary implementation, the component comprises a substrate defining a front side and a back side, and a layer stack below the back side of the substrate, the layer stack comprising a bottom coat layer below the substrate, an Si layer below the bottom coat layer, one or more SiO2 layers below the Si layer, one or more TiO2 layers below and/or between the one or more SiO2 layers, and a top coat layer atop a bottom one of the one or more TiO2 layers.

In some implementations, the layer stack comprises only one SiO2 layer below the Si layer and only one TiO2 layer below the SiO2 layer. In some implementations, the one or more SiO2 layers comprise first and second SiO2 layers and the one or more TiO2 layers comprise first and second TiO2 layers. In some implementations, the first SiO2 layer is below the Si layer, the first TiO2 layer is below the first SiO2 layer, the second SiO2 layer is below the first TiO2 layer, and a second TiO2 layer below the second SiO2 layer. In some implementations, the component defines a high glass side reflectance (Rg) value thereby improving aesthetics and/or performance for an automotive front grille application.

According to yet another aspect of the present application, a component having a decorative metallic finish in the visible wavelength range with high transmission in the IR wavelength range is presented. In one exemplary implementation, the component comprises a substrate defining a front side and a back side, a first layer stack below the back side of the substrate, the first layer stack comprising a first bottom coat layer below the substrate, a first enhanced transmission/visibility layer below the bottom coat layer, and a first top coat later below the first bottom coat layer, and a second layer stack atop the substrate, the second layer stack comprising a second bottom coat layer atop the substrate, a second enhanced transmission/visibility layer atop the bottom coat layer, and a first top coat later atop the first bottom coat layer.

In some implementations, the component does not include a silicon or silicon-based layer. In some implementations, the first enhanced transmission visibility layer comprises, from top to bottom: a first base coat layer, a first TiO2 layer, a first SiO2 layer, a second TiO2 layer, a second SiO2 layer, and a first top coat layer. In some implementations, the second enhanced transmission visibility layer comprises, from top to bottom: a second base coat layer, a third TiO2 layer, a third SiO2 layer, a fourth TiO2 layer, a fourth SiO2 layer, and a second top coat layer. In some implementations, the component defines transmission greater than or equal to 90% at a 940 nanometer wavelength.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the description of the present application are intended to be within the scope of the present application.

### BRIEF DESCRIPTION OF THE DRAWINGS

The present disclosure will become more fully understood from the detailed description and the accompanying drawings, wherein:

FIGS. 1A-1B illustrate optical modeling and stack details of a first embodiment of a component having a decorative metallic finish in the visible wavelength range with high transmission in the infrared (IR) wavelength range according to the principles of the present application;

FIGS. 2A-2B illustrate optical modeling and stack details of a second embodiment of the above-described component according to the principles of the present application;

FIGS. 3A-3B illustrate optical modeling and stack details of a third embodiment of the above-described component according to the principles of the present application;

FIGS. 4A-4B illustrate optical modeling and stack details of a fourth embodiment of the above-described component according to the principles of the present application; and

FIGS. 5A-5B illustrate optical modeling and stack details of a fifth embodiment of the above-described component according to the principles of the present application.

### DETAILED DESCRIPTION

As previously discussed, metallic finish is defined as chrome appearance with a typical chrome plated finish and the focus for infrared (IR) wavelength range is 900 nanometers (nm) to 1550 nm, based on existing light detection and ranging (LIDAR) solutions. The functional wavelength, however, may be different depending on the LIDAR design/technology (905 nm, 940 nm, 1550 nm, etc.). For LIDAR applications, IR transmission greater than 85% is required, greater than 90% is preferred, and greater than 95% most preferred. Challenges for exterior automotive applications with high performance requirements include performance not known for concepts, appearance matching with chrome plating, transmission at IR wavelengths, whether to target specific wavelengths or the entire range, metal films typically not having the required IR transmission, and the like.

Other conventional solutions include mold-in-color (MIC) black plastic, which include commercially available grades of plastic resin exist that are formulated for IR transmission and having a pigment package to allow for IR transmission. Another conventional solution is a film solution, such as a polypropylene film to provide a metallic appearance finish. It works for this film because no metals are used, making it a viable but limited solution (i.e., limited to film application. Further investigation would also be required to understand the optimal cost, appearance, functionality and performance. Typically, physical vapor deposition (PVD) will provide more freedom for part geometry. Examples include radius, tight corners, depth. Thus, while these conventional metallic finish LIDAR devices do work for their intended purpose, there exists and opportunity for improvement in the relevant art.

According to some implementations of the present disclosure, an improved decorative finish with metallic appearance in the visible wavelength range with high transmission in the infrared (IR) wavelength range is presented. A first surface PVD coating stack includes silicon as a color layer and a quarter wave stack for improved IR transmission. Base coat and top coat paints included can be included to provide exterior automotive performance. For example, standard paints for today's PVD solutions could be used. We reference a quarter wave stack as it is a standard optical approach. However, the present application is not be limited to quarter wave stacks. The components/stacks described and illustrated herein will have more flexibility with the target wavelength range. In one embodiment, silicon dioxide (SiO2) is used as a representative “low index” material, but it will be appreciated that alternative materials can be used. Titanium dioxide (TiO2) is also used as a representative “high index” material, but it will be appreciated that alternative materials can be used. Plastic substrates with IR transmission should be required. Design concepts and embodiments are as follows: (1) silicon (Si) color layer only, (2) Si color layer with SiO2-TiO2 quarter wave stack, (3) Si color layer with multiple SiO2-TiO2 quarter wave stacks, (4) a B-side execution of (3), and (5) enhanced reflection layers on both sides of the substrate (no Si color layer).

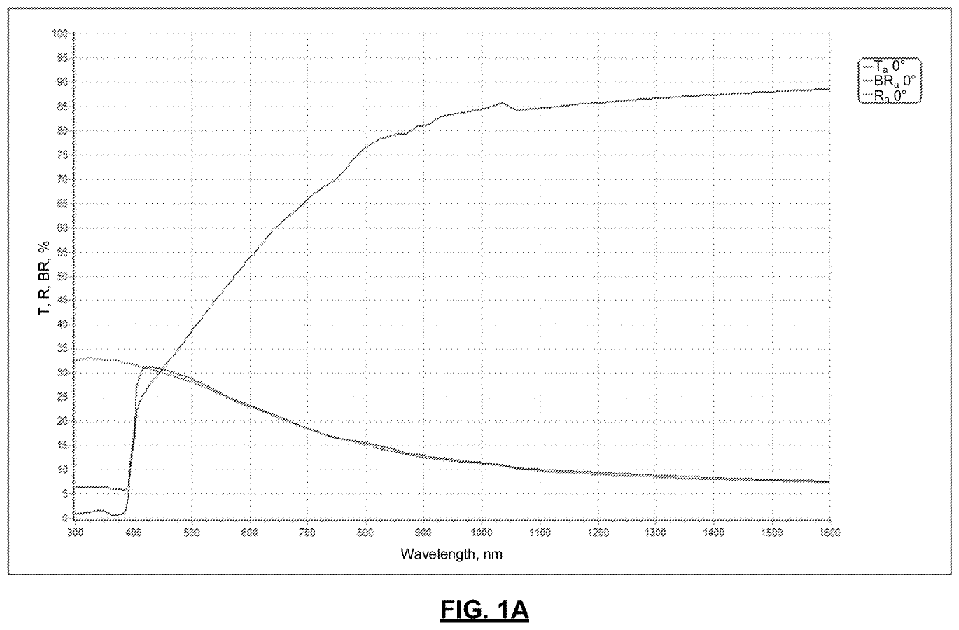

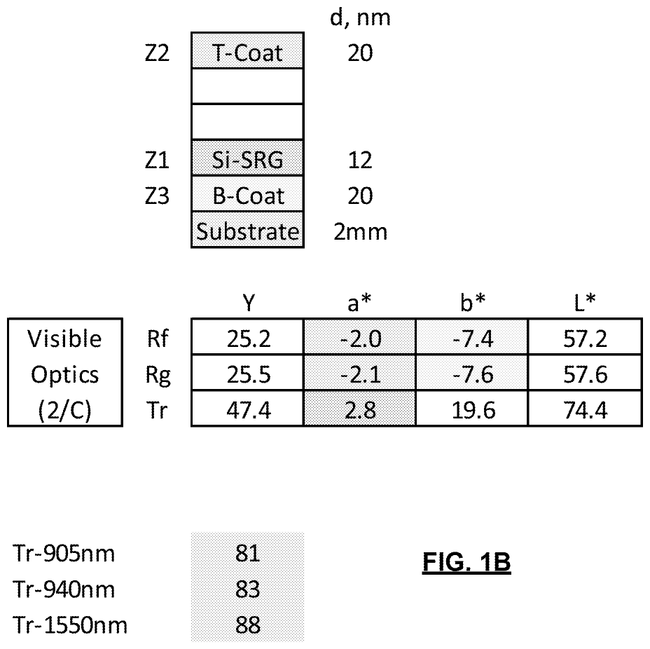

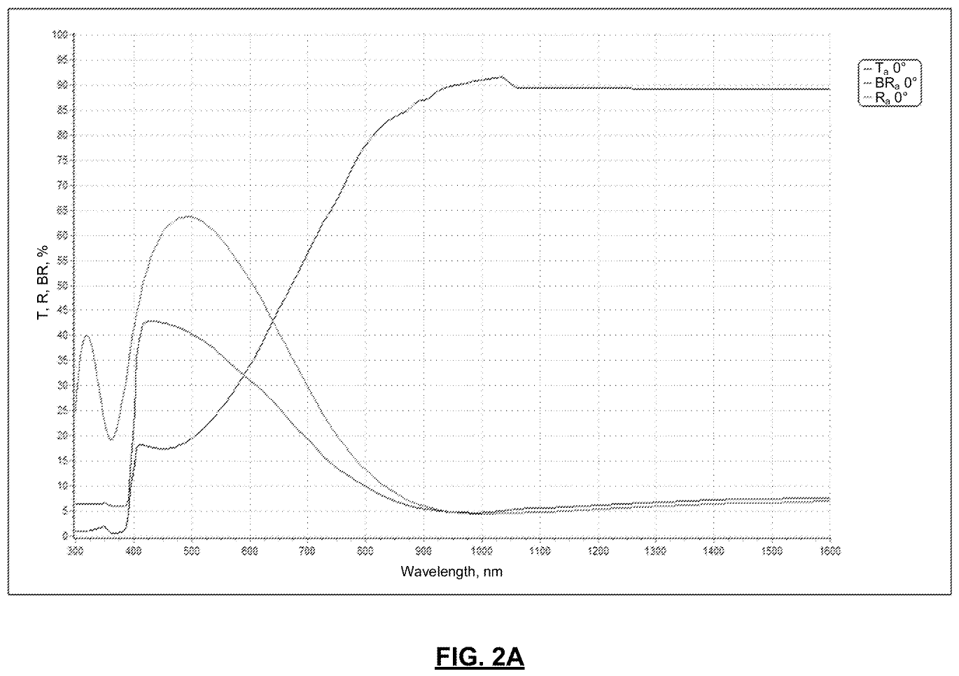

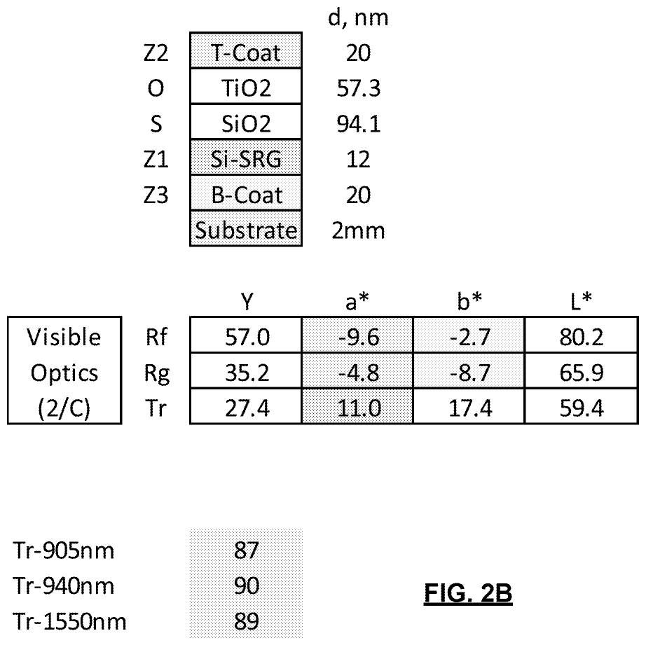

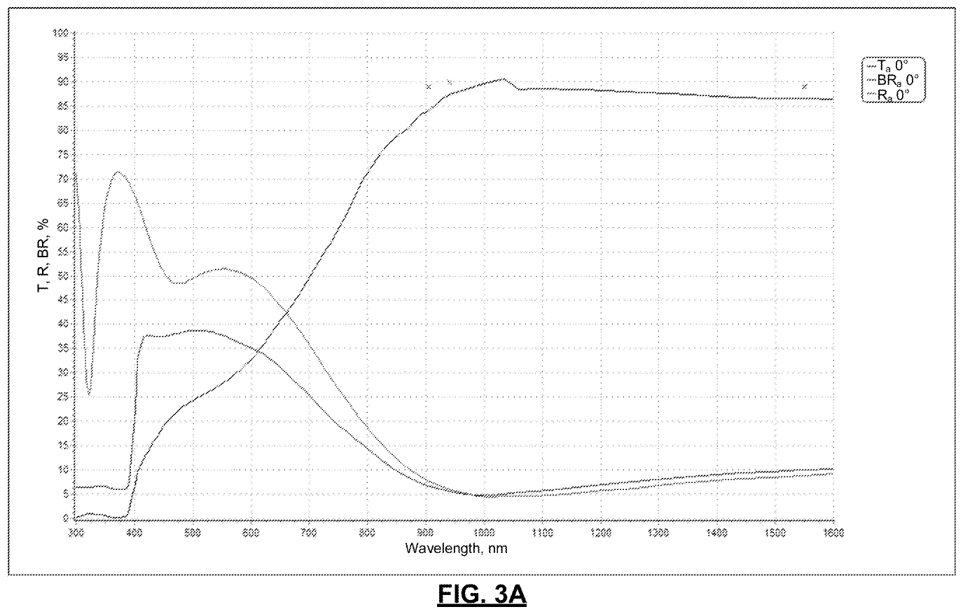

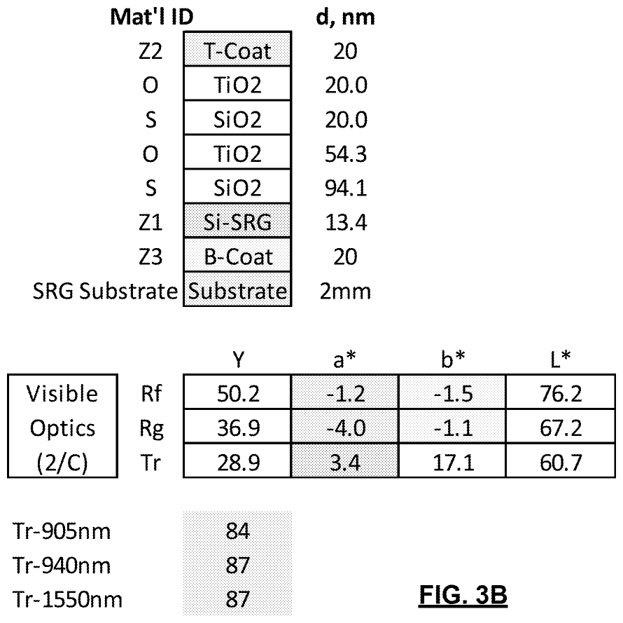

Referring now to FIGS. 1A-1B, optical modeling and details of the first embodiment (1) of the present disclosure are illustrated. Potential benefits of this design include the performance of A-side appearance film for an automotive system. However, the required IR transmission may not be achieved, reflectance may be relatively low, visible transmission may be high, and/or the b* parameter may increase as thickness increases, but this affects IR transmission. Referring now to FIGS. 2A-2B, optical modeling and details of the second embodiment (2) of the present disclosure are illustrated. Potential benefits of this design include improved visual appearance (better match with chrome plating) and preferred IR transmission achieved. However, there may be a bluish-green reflected color (not neutral, not similar to chrome color) and/or there may be a strong transmitted color (which may not matter). Referring now to FIGS. 3A-3B, optical modeling and details of the third embodiment (3) of the present disclosure are illustrated. Potential benefits of this design include required IR transmission achieved and preferred film side color/reflectance achieved (minimum target for L*). However, this may be a more complex process due to increasing the number of layers.

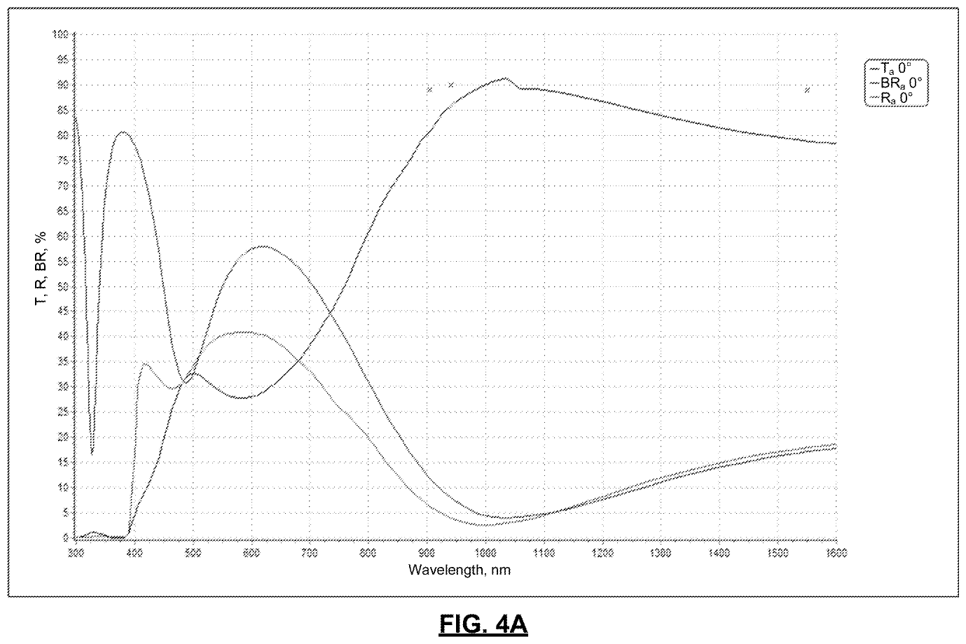

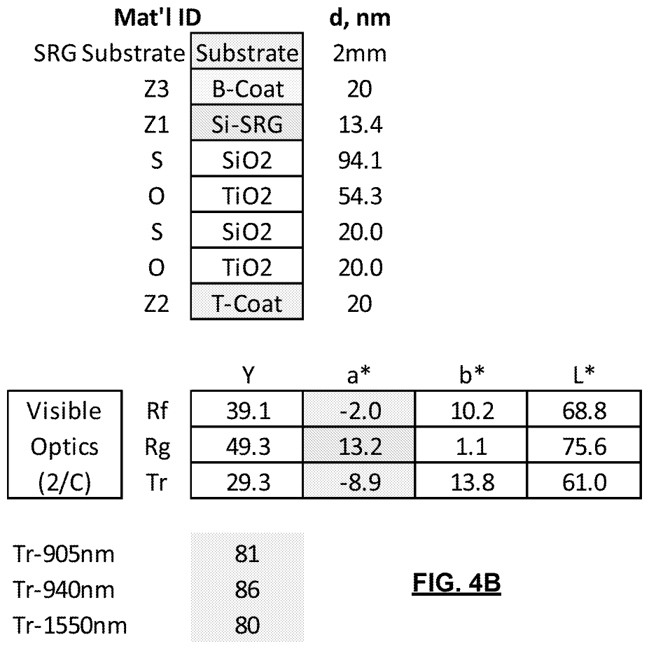

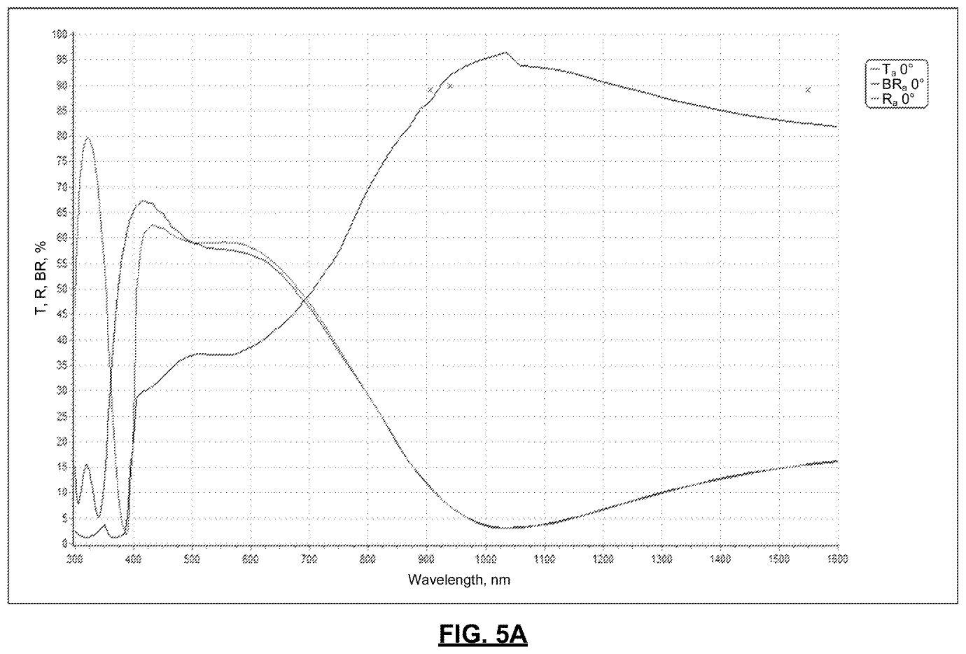

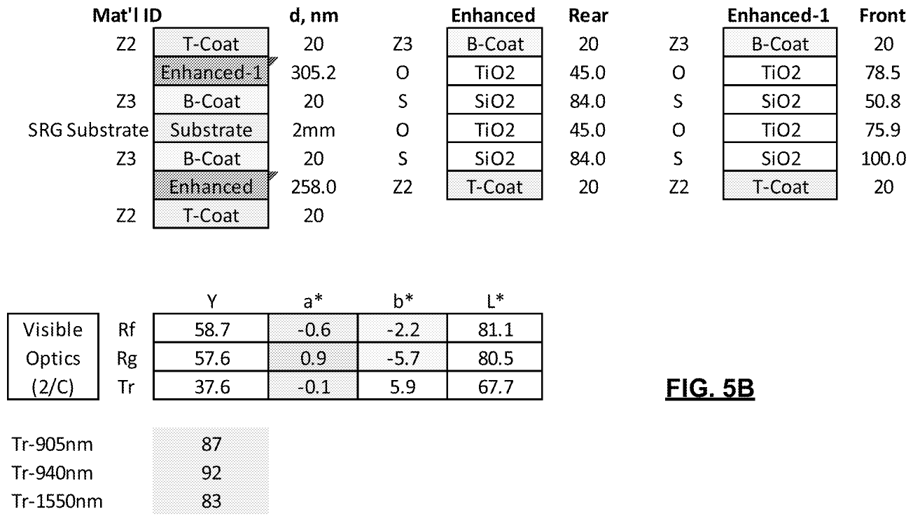

Referring now to FIGS. 4A-4B, optical modeling and details of the fourth embodiment (4) of the present disclosure are illustrated. Potential benefits of this design include required IR transmission achieved. However, this may be a more complex process due to increasing number of layers and/or the glass side color may be red. This particular embodiment is particularly relevant for front grilles of automobiles. Rg (reflectance glass side) is an important variable for B-side execution. B-side execution is a need for some applications as previously discussed. Referring now to FIGS. 5A-5B, optical modeling and details of the fifth embodiment (5) of the present disclosure are illustrated. Potential benefits of this design include enhanced reflection layers on both sides of the substrate, increased T-IR transmission, high reflectance, meeting the front side desired reflected color range, and transmission>90% at 940 nm. In addition, similar stacks could be provided on both sides of substrate, manufacturing could be easier, and no Si layers may be required. However, this may be a more complex layers/process and/or could suffer from thick and/or low DDR dielectric layers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A component having a decorative metallic finish in the visible wavelength range with high transmission in the infrared (IR) wavelength range, the component comprising:
a substrate defining a front side and a back side; and
a layer stack atop the front side of the substrate, the layer stack comprising:
a bottom coat layer atop the substrate;
a silicon (Si) layer atop the bottom coat layer;
one or more silicon dioxide (SiO2) layers atop the Si layer;
one or more titanium dioxide (TiO2) layers atop and/or between the one or more SiO2 layers; and
a top coat layer atop a top one of the one or more TiO2 layers.

2. The component of claim 1, wherein the layer stack comprises only one SiO2 layer atop the Si layer and only one TiO2 layer atop the SiO2 layer.

3. The component of claim 1, wherein:
the one or more SiO2 layers comprise first and second SiO2 layers and the one or more TiO2 layers comprise first and second TiO2 layers;

4. The component of claim 3, wherein:
the first SiO2 layer is atop the Si layer;
the first TiO2 layer is atop the first SiO2 layer;
the second SiO2 layer is atop the first TiO2 layer; and
a second TiO2 layer atop the second SiO2 layer.

5. The component of claim 4, wherein the component defines transmission greater than 87% at a 940 nanometer wavelength

6. A component having a decorative metallic finish in the visible wavelength range with high transmission in the infrared (IR) wavelength range, the component comprising:
a substrate defining a front side and a back side; and
a layer stack below the back side of the substrate, the layer stack comprising:
a bottom coat layer below the substrate;
a silicon (Si) layer below the bottom coat layer;
one or more silicon dioxide (SiO2) layers below the Si layer;
one or more titanium dioxide (TiO2) layers below and/or between the one or more SiO2 layers; and
a top coat layer atop a bottom one of the one or more TiO2 layers.

7. The component of claim 6, wherein the layer stack comprises only one SiO2 layer below the Si layer and only one TiO2 layer below the SiO2 layer.

8. The component of claim 6, wherein the one or more SiO2 layers comprise first and second SiO2 layers and the one or more TiO2 layers comprise first and second TiO2 layers.

9. The component of claim 8, wherein:
the first SiO2 layer is below the Si layer;
the first TiO2 layer is below the first SiO2 layer;
the second SiO2 layer is below the first TiO2 layer; and
a second TiO2 layer below the second SiO2 layer.

10. The component of claim 9, wherein the component defines a high glass side reflectance (Rg) value thereby improving aesthetics and/or performance for an automotive front grille application.

11. A component having a decorative metallic finish in the visible wavelength range with high transmission in the infrared (IR) wavelength range, the component comprising:
a substrate defining a front side and a back side;
a first layer stack below the back side of the substrate, the first layer stack comprising:
a first bottom coat layer below the substrate;
a first enhanced transmission/visibility layer below the bottom coat layer; and
a first top coat later below the first bottom coat layer; and
a second layer stack atop the substrate, the second layer stack comprising:
a second bottom coat layer atop the substrate;
a second enhanced transmission/visibility layer atop the bottom coat layer; and
a first top coat later atop the first bottom coat layer.

12. The component of claim 11, wherein the component does not include a silicon or silicon-based layer.

13. The component of claim 11, wherein the first enhanced transmission visibility layer comprises, from top to bottom:
a first base coat layer;
a first titanium dioxide (TiO2) layer;
a first silicon dioxide (SiO2) layer;
a second TiO2 layer;
a second SiO2 layer; and
a first top coat layer.

14. The component of claim 1413, wherein the second enhanced transmission visibility layer comprises, from top to bottom:
a second base coat layer;
a third TiO2 layer;
a third SiO2 layer;
a fourth TiO2 layer;
a fourth SiO2 layer; and
a second top coat layer.

15. The component of claim 14, wherein the component defines transmission greater than or equal to 90% at a 940 nanometer wavelength.
